(19) United States
(12) Patent Application Publication
(10) Pub. No.: US 2024/0194379 A1
(43) Pub. Date: Jun. 13, 2024

(54) R-T-B BASED PERMANENT MAGNET MATERIAL, PREPARATION METHOD THEREFOR AND USE THEREOF

(71) Applicant: YANTAI ZHENGHAI MAGNETIC MATERIAL CO., LTD., Yantai (CN)

(72) Inventors: Buzhuang PENG, Yantai (CN); Yunying JIANG, Yantai (CN); Meng LI, Yantai (CN); Yuhao DONG, Yantai (CN); Lei LIU, Yantai (CN)

(21) Appl. No.: 18/536,652

(22) Filed: Dec. 12, 2023

(30) Foreign Application Priority Data
Dec. 13, 2022 (CN) 202211600057.6

(51) Int. Cl. H01F 1/057; B22F 1/10; B22F 1/16; B22F 3/16; B22F 3/24; B22F 9/02; B22F 9/04; C22C 33/04; C22C 38/00; C22C 38/06; C22C 38/10; C22C 38/14; C22C 38/16

(52) U.S. Cl. CPC H01F 1/0577; B22F 1/10; B22F 1/16; B22F 3/16; B22F 3/24; B22F 9/023; B22F 9/04; C22C 33/04; C22C 38/002; C22C 38/005; C22C 38/06; C22C 38/10; C22C 38/14; C22C 38/16; B22F 2003/242; B22F 2003/248; B22F 2009/044; B22F 2201/20; B22F 2202/05; B22F 2301/355; B22F 2304/10; B22F 2998/10; B22F 2999/00; C22C 2202/02

(57) ABSTRACT

An R-T-B based permanent magnet material, a preparation method therefor and use thereof are provided. The M compound is adhered to or coats the R-T-B based alloy powders to form a uniform coating layer on the surface of the neodymium-iron-boron powders, so that the rounding transformation of the R-T-B based alloy powders can be achieved, and further the wettability of the R-T-B based alloy powders is improved under the condition of significantly reducing the amount of heavy rare earth metals in the substrate. In addition, the grain boundary phases of M-R and/or M-T-R are present in the grain boundary of the R-T-B based permanent magnet material, the physicochemical properties of the grain boundary phases can be significantly improved, the distribution of the grain boundary phases is improved, and the grain boundary is strengthened.

The present application claims priority to the prior patent application with the application No. 202211600057.6 and entitled “R-T-B BASED PERMANENT MAGNET T MATERIAL, PREPARATION METHOD THEREFOR AND USE THEREOF”, filed with the China National Intellectual Property Administration on Dec. 13, 2022, which is incorporated herein by reference in its entirety.

### TECHNICAL FIELD

The present disclosure relates to the field of magnet materials, and particularly, to an R-T-B based permanent magnet material, a preparation method therefor and use thereof.

### BACKGROUND

The permanent magnet material is also called hard magnetic material, and is characterized by high anisotropy field, high coercivity, large hysteresis loop area, large magnetization field required for magnetization to saturation, and capability of keeping strong magnetism for a long time after an external magnetic field is removed. Among permanent magnet materials, sintered neodymium-iron-boron (NdFeB) based permanent magnets have more outstanding magnetic property advantages than other permanent magnet materials. For example, the sintered NdFeB based permanent magnets have higher magnetic energy product, coercivity and energy density, have good mechanical property, and are easy to process. These excellent properties make the sintered NdFeB permanent magnets widely used in modern industry and electronics, more commonly in motors, loudspeakers, magnetic separators, computer disk drives, magnetic resonance imaging devices, and the like.

The basic properties of the magnetic material can be evaluated by the following four performance parameters: remanence (i.e., residual magnetic induction) Br, coercivity Hcb, intrinsic coercivity Hej, and maximum energy product (BH)max. The method for improving the property of the sintered NdFeB based permanent magnet generally comprises the optimization of a grain boundary structure, the regulation and control of intragranular and grain-boundary components, a grain boundary diffusion technology, and the like. In general, although it is a method known in the art to increase the coercivity of a magnet by adding a heavy rare earth metal element HRE (e.g., Dy, Tb), the amount of the scarce heavy metal element added needs to be increased if the heavy rare earth element fails to achieve enrichment in the grain boundary phase, resulting in high cost. In practice, the existing sintered NdFeB based permanent magnet also has the problems of insufficient grain shape, a lot of defects on the grain surface layers and the grain boundaries, and the like, so Dy or Tb suffers from relatively large resistance when diffusing to the interior of the magnet along the grain boundaries, defects are easily repaired on the grain surface layers, or the Dy or Tb permeates into main phase grains, and the Dy or Tb cannot continuously diffuse to the interior of the magnet along the grain boundaries, and thus the phenomenon of insufficient Hcj amplification occurs, and a reverse core-shell structure is easily formed on the surface of the magnet and is not favorable for diffusion.

In addition, researchers uniformly and continuously put neodymium-rich phases around a hard magnetic main phase to obtain clean and smooth grain boundaries so as to improve the coercivity. However, this method requires a complicated sintering process, not only the cost is high, but also the complexity of the process causes difficulty in maintaining stability of product performance. Therefore, further development of the composition of a sintered NdFeB based permanent magnet and a preparation method therefor is required to improve the technical problems described above.

### SUMMARY

In order to solve the problems described above, the present disclosure provides an R-T-B based permanent magnet material, wherein the R is selected from one or two of neodymium (Nd) and praseodymium (Pr); the T comprises at least iron (Fe); the B is boron;
the permanent magnet material further comprises M, wherein the M is selected from one or more of transition metal elements, non-metal elements, and light rare earth elements;
a grain boundary of the permanent magnet material comprises an M compound selected from one, two, or more of compounds M-R and M-T-R.

According to an embodiment of the present disclosure, the R is preferably selected from Nd and NdPr.

According to an embodiment of the present disclosure, the T is selected from iron (Fe) and a mixture of iron and another metal element, wherein preferably, the another metal element may be selected from one or more of transition metal elements other than iron.

The transition metal elements in the context of the present disclosure have the meaning well known in the art and refer to the metal elements of regions d and ds in the periodic table of elements, wherein the elements of region d include elements of groups IIIB to VIIB, VIII, but exclude lanthanides and actinides; the elements of region ds include elements of groups IB to IIB. Generally, the transition metal elements include elements of a total of ten groups of 3 to 12, but exclude internal transition elements of region f (elements No. 58 to 71 in the periodic table are called internal transition elements of 4f, and elements No. 90 to 103 are called internal transition elements of 5f, all of which are elements of region f).

According to an embodiment of the present disclosure, the another metal element may be selected from one or more of copper (Cu), gallium (Ga), aluminum (Al), zirconium (Zr), titanium (Ti), tin (Sn), tantalum (Ta), and manganese (Mn).

According to an embodiment of the present disclosure, the light rare earth element may be selected from cerium group rare earth elements, such as lanthanum (La), cerium (Ce), praseodymium (Pr), neodymium (Nd), promethium (Pm), samarium (Sm), and europium (Eu).

According to an embodiment of the present disclosure, the M is preferably selected from one or more of Cu, Ga, Al, Zr, Ti, Sn, Ta, and Mn, such as one or more of Cu, Ga, and Al.

According to an embodiment of the present disclosure, the grain boundary of the permanent magnet material comprises a grain boundary phase selected from one or two of a grain boundary phase of a compound M-R and a grain boundary phase of M-T-R.

The grain boundary of the permanent magnet material comprises an enrichment region selected from grain boundary phases of M-R and/or M-T-R, wherein the enrichment region of M-R and/or M-T-R in the grain boundary phases refers to a region in which the concentration of the compound M-R and/or M-T-R is not less than 115% of an average concentration of an entire scanning region.

According to an embodiment of the present disclosure, the grain boundary phases of M-R and/or M-T-R, when present, are enriched in the grain boundary of the permanent magnet material, wherein the enrichment region of M-R and/or M-T-R in the grain boundary phases accounts for 2% to 18%, preferably 5% to 15%, even more preferably 8% to 12%, of an entire visual field area.

According to an embodiment of the present disclosure, the entire visual field area refers to the entire visual field area shown in the grain boundary detection image obtained by EMPA, SEM, or other methods known in the art.

According to an embodiment of the present disclosure, the grain boundary of the permanent magnet material comprises a grain boundary phase selected from one or two of grain boundary phases of M-Nd and M-Fe—Nd.

According to an embodiment of the present disclosure, the mass percentage of the R is not less than 28.5% and not more than 32.5%, based on the mass of the permanent magnet material, and an example thereof may be 28.5%, 29.0%, 29.5%, 30.0%, 30.5%, 31.0%, 31.5%, 32.0%, or 32.5%.

According to an embodiment of the present disclosure, the mass percentage of the B is not less than 0.88% and not more than 1.05%, based on the mass of the permanent magnet material, and an example thereof may be 0.88%, 0.90%, 0.92%, 0.95%, 0.98%, 1.00%, 1.02%, or 1.05%.

According to an embodiment of the present disclosure, the total mass percentage of the M is not less than 0.1% and not more than 4.0%, preferably not less than 0.3% and not more than 3.5%, based on the mass of the permanent magnet material, and an example thereof may be 0.3%, 0.5%, 1.0%, 1.5%, 2.0%, 2.5%, 3.0%, or 3.5%.

According to an embodiment of the present disclosure, the permanent magnet material comprises Ga. Preferably, the mass percentage of the Ga is not less than 0.1% and not more than 0.6%, based on the mass of the permanent magnet material, and an example thereof may be 0.1%, 0.2%, 0.3%, 0.4%, 0.5%, or 0.6%.

According to an embodiment of the present disclosure, the permanent magnet material comprises Co. Preferably, the mass percentage of the Co is not less than 0% and not more than 3.0%, preferably not less than 0% and not more than 3.0%, based on the mass of the permanent magnet material, and an example thereof may be 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, or 3.0%.

According to an embodiment of the present disclosure, the permanent magnet material comprises Cu. Preferably, the mass percentage of the Cu is not less than 0% and not more than 0.4%, preferably not less than 0% and not more than 0.4%, based on the mass of the permanent magnet material, and an example thereof may be 0.1%, 0.2%, 0.3%, or 0.4%.

According to an embodiment of the present disclosure, the balance of the permanent magnet material is Fe and an inevitable impurity, wherein the inevitable impurity is, for example, at least one of C, N, O, and the like.

According to an embodiment of the present disclosure, when present, the mass percentage of the C is 400-800 ppm, based on the mass of the permanent magnet material.

According to an embodiment of the present disclosure, when present, the mass percentage of the O is 300-900 ppm, based on the mass of the permanent magnet material.

According to an embodiment of the present disclosure, when present, the mass percentage of the Nis 400-800 ppm, based on the mass of the permanent magnet material.

According to an embodiment of the present disclosure, the grain boundary of the permanent magnet material may further comprise an M compound selected from one or more of compounds M-C, M-B, and M-O.

According to an embodiment of the present disclosure, the permanent magnet material further comprises a heavy rare earth element (HRE), wherein the heavy rare earth element has a meaning well known in the art, and an example thereof may be selected from one or more of gadolinium (Gd), terbium (Tb), dysprosium (Dy), holmium (Ho), erbium (Er), thulium (Tm), ytterbium (Yb), lutetium (Lu), and yttrium (Y).

According to an embodiment of the present disclosure, in the diffused permanent magnet material, the M is more concentrated in the grain boundary phases between two main phase particles, and therefore the concentration distribution curve of the M has sharp distribution between the two main phase particles.

According to an embodiment of the present disclosure, a region A with an element concentration of the M being not less than 0.15 at % is present in a cross section of the permanent magnet material and in an R-rich phase, and the ratio (also referred to as the degree of coincidence of R-M) of the area of the region A to the area of the R-rich phase is preferably not less than 80%, more preferably not less than 90%; an example of the ratio of the area of the region A to the area of the R-rich phase may be, for example, 80%, 81%, 82%, 83%, 84%, 85%, 86%, 87%, 88%, 89%, 90%, 91%, 92%, 93%, 94%, 95%, 96%, 97%, or 98%.

The present disclosure further provides a mixture of R-T-B based alloy powders, which comprises the R-T-B based alloy powders and an M compound selected from one or more of M compounds, wherein the R, T, B, and M independently have the definitions described above.

According to an embodiment of the present disclosure, the M compound is adhered to the surface of the R-T-B based alloy powders.

According to an embodiment of the present disclosure, at least a part of the surface of the alloy powders is covered with the M compound, wherein the R, T, B, and M have the definitions described above.

According to an embodiment of the present disclosure, the mass percentage of the M compound in the mixture is 0.01% to 5.0%, preferably 0.05% to 3.0%, more preferably 0.1% to 2.0%, based on the mass of the R-T-B based alloy powders in the mixture, and an example thereof may be 0.01%, 0.02%, 0.05%, 0.08%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, or 5.0%.

According to an embodiment of the present disclosure, the M compound is selected from one or more of hydrides, carbides, oxides, nitrides, fluorides, and oxyfluorides of the M.

According to an embodiment of the present disclosure, the surface of the alloy powders is preferably completely coated with the M compound to form a coating layer.

According to an embodiment of the present disclosure, the M compound is present in the mixture in the form of a powder, for example, adhered to or coats the surface of the alloy powders in the form of a powder.

According to an embodiment of the present disclosure, the M compound has an average particle size of not more than 500 μm, for example, 1 μm to 300 μm, preferably 3 μm to 200 μm, more preferably 10 μm to 100 μm, and an example thereof may be 10 μm, 20 μm, 30 μm, 40 μm, 50 μm, 60 μm, 70 μm, 80 μm, 90 μm, or 100 μm.

According to an embodiment of the present disclosure, the mixture of the R-T-B based alloy powders does not comprise a heavy rare earth element.

The present disclosure further provides an R-T-B based magnet substrate, which comprises a sintered substrate comprising the mixture of the R-T-B based alloy powders, and a heavy rare earth element. For example, the heavy rare earth element is adhered to the surface of the substrate.

According to an embodiment of the present disclosure, in the R-T-B based magnet substrate comprising a heavy rare earth, the surface of the substrate is completely coated with the heavy rare earth element to form a coating layer.

According to an embodiment of the present disclosure, the method for preparing the sintered substrate comprising the R-T-B based alloy powders comprises: molding the mixture of the R-T-B based alloy powders into a molded body, and then sintering the molded body to obtain the sintered substrate comprising the R-T-B based alloy powders.

According to an embodiment of the present disclosure, the molding step or the sintering step may be performed using conditions known in the art.

According to an embodiment of the present disclosure, in the molding step, the mixture of the R-T-B based alloy powders may be dry-molded. For example, a mold disposed in a magnetic field is filled with the mixture of the R-T-B based alloy powders followed by pressurization to mold the mixture of the R-T-B based alloy powders into a molded body. In this case, by applying a magnetic field while molding, the mixture of the R-T-B based alloy powders may be molded with the crystallographic axes being oriented in a specific direction. In the molding step, a molding adjuvant known in the art may be added as needed. Preferably, the pressure during pressurization may be, for example, not less than 30 MPa and not more than 300 MPa; the applied magnetic field may be a static magnetic field and/or a pulsed magnetic field, and the magnetic field intensity thereof may be, for example, not less than 1000 kA/m and not more than 1600 kA/m. Alternatively, wet molding may be adopted, and specifically, a mixture of the R-T-B based alloy powders is dispersed in a slurry of a solvent such as oil, followed by molding.

It should be understood by those skilled in the art that the specific shape of the molded body is not particularly limited, and may be adjusted according to the application conditions of the R-T-B based permanent magnet material. For example, the molded body may have a rectangular parallelepiped shape, a flat plate shape, a columnar shape, a ring shape, a C-shape, or the like.

According to an embodiment of the present disclosure, in the sintering step, the obtained molded body is sintered under vacuum or under an inert gas atmosphere. As an example, the sintering temperature may be not less than 1000° C. and not more than 1150° C., or not less than 1020° C. and not more than 1130° C. The sintering time is not particularly limited, and may be, for example, not less than 2 hours and not more than 10 hours, or not less than 2 hours and not more than 8 hours. The atmosphere during sintering is not particularly limited. For example, the atmosphere may be an inert atmosphere, a vacuum atmosphere of less than 100 Pa, or a vacuum atmosphere of less than 10 Pa. After the molded body is sintered to obtain a sintered body, it may be cooled. The cooling rate is not particularly limited, but the sintered body may be rapidly cooled, for example, at a rate of not less than 20° C./min, in order to improve the productivity.

According to an embodiment of the present disclosure, after the sintered body is formed after sintering, the sintered magnet may be subjected to an aging treatment. After sintering, the obtained sintered magnet is kept at a temperature lower than that during sintering, and the sintered R-T-B based rare earth type magnet is subjected to the aging treatment. The magnetic property of the sintered R-T-B based rare earth type magnet can be improved by the aging treatment.

As an example, the aging treatment may be selected from the following first aging treatment and/or second aging treatment.

The first aging treatment may be performed at a temperature of not less than 800° C. and not more than 950° C. and maintained for not less than 30 minutes and not more than 4 hours; the rate of heating to that temperature may be not less than 5° C./min and not more than 50° C./min; the atmosphere for the first aging treatment may be an inert gas atmosphere (e.g., He gas or Ar gas) with a pressure being not less than the atmospheric pressure.

The second aging treatment may be performed under the same conditions as the first aging treatment, but the temperature may be not less than 450° C. and not more than 550° C.

Alternatively, the aging treatment procedure may be performed after the processing procedure described below. The processing procedure may be performed as needed to process the obtained sintered magnet into a desired shape. As an example, the processing procedure may comprise shape processing such as cutting, grinding, and the like, and chamfering processing such as barrel polishing, and the like.

The present disclosure further provides a method for preparing the R-T-B based permanent magnet material, which comprises performing a heat treatment on the R-T-B based magnet substrate. Preferably, the heat treatment includes a thermal diffusion treatment and a tempering treatment.

According to an embodiment of the present disclosure, the thermal diffusion treatment is a grain boundary diffusion treatment, and the treatment method thereof is a process known in the art. The temperature of the thermal diffusion treatment may be not less than 800° C., for example, 850° C. to 950° C., and an example thereof may be 800° C., 810° C., 820° C., 830° C., 840° C., 850° C., 860° C., 870° C., 880° C., 890° C., or 900° C. The time for the thermal diffusion treatment may be not less than 5 hours, for example, 10 hours to 50 hours, such as 10 hours, 15 hours, 20 hours, 25 hours, 30 hours, 35 hours, 40 hours, 45 hours, or 50 hours.

According to an embodiment of the present disclosure, the temperature of the tempering treatment may be not more than 700° C., for example, 450° C. to 650° C., and an example thereof may be 450° C., 460° C., 470° C., 480° C., 490° C., 500° C., 510° C., 520° C., 530° C., 540° C., 550° C., 560° C., 570° C., 580° C., 590° C., 600° C., 610° C., 620° C., 630° C., 640° C., or 650° C. The time for the tempering treatment may be not less than 1 hour, for example, 1 hour to 10 hours, and an example thereof may be 1 hour, 2 hours, 3 hours, 4 hours, 5 hours, 6 hours, 7 hours, 8 hours, 9 hours, or 10 hours.

The present disclosure further provides a method for preparing the R-T-B based magnet substrate comprising a heavy rare earth, which comprises:
molding the R-T-B based alloy powders into a molded body of the R-T-B based alloy powders;
sintering the molded body to obtain a sintered substrate comprising the R-T-B based alloy powders; and
enabling the heavy rare earth element to be in contact with the sintered substrate comprising the R-T-B based alloy powders; wherein
preferably, the heavy rare earth element is in contact with the sintered substrate comprising the R-T-B based alloy powders to form a coating layer of the heavy rare earth element on the surface of the substrate.

The present disclosure further provides a method for preparing the mixture of the R-T-B based alloy powders, which comprises: enabling the R-T-B based alloy powders to be in contact with the M compound selected from one or more of M compounds.

According to a preferred embodiment of the present disclosure, the method comprises: enabling the R-T-B based alloy powders to be in contact with a powder of the M compound selected from one or more of M compounds.

According to an embodiment of the present disclosure, the R-T-B based alloy powders and the powder of an M compound selected from one or more of M compounds may be prepared by a powdering process known in the art. The powdering process may be selected from a powder metallurgy process and a hydrogen decrepitation and jet milling process.

According to an exemplary embodiment of the present disclosure, the powder metallurgy process may comprise the steps of performing rapid solidification or arc smelting on the starting materials, performing hydrogen decrepitation, and then performing high-energy ball milling, and the like. The hydrogen decrepitation and jet milling process may comprise the steps of performing rapid solidification or arc smelting on the starting materials, performing hydrogen decrepitation, and then performing jet milling process, and the like.

The present disclosure further provides use of the Re—Fe—B based permanent magnet material described above in the fields of motors, loudspeakers, magnetic separators, computer disk drivers, magnetic resonance imaging devices, and the like, preferably use thereof as a motor rotor steel magnet in motors.

### Advantageous Effect

The inventors have surprisingly found that the M compound is adhered to or coats the R-T-B based alloy powders to form a uniform coating layer on the surface of the NdFeB powders, so that the rounding transformation of the R-T-B based alloy powders can be achieved, and further the wettability of the R-T-B based alloy powders is improved under the condition of significantly reducing the amount of heavy rare earth metals in the substrate. In addition, the grain boundary phases of M-R and/or M-T-R are present in the grain boundary of the R-T-B based permanent magnet material, the physicochemical properties of the grain boundary phases can be significantly improved, the distribution of the grain boundary phases is improved, and the grain boundary is strengthened, so that a reverse core-shell structure can be avoided, and the permeation of heavy rare earth elements is facilitated, so that the Hcj of the R-T-B based permanent magnet material is improved.

### BRIEF DESCRIPTION OF THE DRAWINGS

FIG. 1 is an EMPA detection diagram of sample E11 in Test Example 1.

FIG. 2 is a detection diagram obtained by EPMA line scanning a random region of FIG. 1 in Test Example 1.

FIG. 3 is an EMPA detection diagram of Comparative Example E10 in Test Example 1.

FIG. 4 is a detection diagram obtained by EPMA line scanning a random region of FIG. 3 in Test Example 1.

### DETAILED DESCRIPTION

The embodiments of the present disclosure will be further illustrated in detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared using known methods.

### Instruments and Methods

### [EMPA Assay]

The instrument was a field-emission electron probe microanalyzer (FE-EPMA, JEOL, 8530F).

The test conditions were as follows: the accelerating voltage was 15 kV, and the beam current of the probe was 50 nA.

### [Magnetic Property Test]

The instrument was an NIM-62000 type rare earth permanent magnet measuring system from the National Institute of Metrology.

The test condition: room temperature

### [Weight Loss Performance Test]

The instrument was a D10-10 sample column, Japanese ESPEC high-temperature and high-humidity tester.

The test conditions were as follows: 130° C., 95% RH, 2.6 Bar, and 240 H.

### [Anti-Bending Strength Test]

The instrument was a three-point anti-bending device.

The test conditions were conditions stipulated by GB/T 14452-93 (three-point bending).

### Preparation Example 1: Preparation of Nd—Fe—B Powders

(1) Ingredients: various starting materials required for this example were prepared according to the neodymium-iron-boron (NdFeB) powder formula in Table 1.

TABLE 1
NdFeB powder formula (unit: wt %)

| | PrNd | Dy | Ho | Co | Cu | Ga | Al | Ti | B | Fe |
|---|---|---|---|---|---|---|---|---|---|---|
| A11 | 28.6 | 1.2 | 0 | 1.0 | 0.10 | 0.25 | 0.10 | 0.12 | 1.00 | Balance |

(2) The starting materials were high-frequency melted under an Ar atmosphere and then casted on a quenching roller to give a rapidly-solidified alloy scale A11 with a thickness of 0.15-0.40 mm.

(3) The alloy was subjected to hydrogenation pulverization and then to jet milling to give a magnetic powder with particle size SMD of 2.6 μm.

### Preparation Example 2: Preparation of M Compound Powders

The following M compounds were obtained by powder metallurgy process or hydrogen decrepitation and jet milling process or purchased from the market, and the average particle sizes of powder samples B1, B2, B3, B4, B5, and B6 are shown in the following table.

| | | Average particle | Percentage |
|---|---|---|---|
| Powder sample | M compound | size (μm) | (%) |
| B1 | Copper nitride | 10 | 0.05 |
| B2 | Aluminum nitride | 20 | 0.1 |
| B3 | Aluminum oxide | 30 | 0.2 |
| B4 | Copper oxide | 50 | 1.0 |
| B5 | Tantalum carbide | 20 | 0.5 |
| B6 | Copper fluoride | 80 | 1.5 |

### Example 1: Preparation of Mixture of Nd—Fe—B Based Alloy Powders

The samples obtained in Preparation Example 1 and the samples obtained in Preparation Example 2 were respectively and uniformly mixed, and after 0.2 wt % (by weight of the uniformly mixed powder) of lubricant zinc stearate was added, the materials were mixed such that the surfaces of the NdFeB powders were completely or incompletely coated with M compounds to form coating layers of the M compounds.

The A11 scales were respectively taken at different stages of powder preparation, and M compound powders of different proportions were added to give samples C11-C16.

Specific samples are shown in the following table:

| | |
|---|---|
| Sample in Preparation | Sample in Preparation |
| Example 1 | Example 2 |

| | | Amount | | Amount |
|---|---|---|---|---|
| Sample | Species | (kg) | Species | (kg) |
| C11 | A11 | 99.95 | B1 | 0.05 |
| C12 | A11 | 99.90 | B2 | 0.1 |
| C13 | A11 | 99.80 | B3 | 0.2 |
| C14 | A11 | 99.00 | B4 | 1.0 |
| C15 | A11 | 99.50 | B5 | 0.5 |
| C16 | A11 | 98.50 | B6 | 1.5 |

### Example 2: Preparation of Sintered Body of Nd—Fe—B Based Alloy Powder Mixture

Samples C11, C12, C13, C14, C15, and C16 in Example 1 were processed as follows to give sintered body samples D11, D12, D13, D14, D15, and D16 of the Nd—Fe—B based alloy powder mixture, respectively.

### (1) Molding

Samples C11, C12, C13, C14, C15, and C16 in Example 1 were compression-molded in an oriented magnetic field to form pressed compacts with a density of 3.6-4.2 g/cm³, wherein the field intensity of the oriented magnetic field was 2-8 T, then the pressed compacts were subjected to isostatic pressing to obtain a further increased density, and then pressed compacts without fine cracks inside were formed.

### (2) Sintering

The pressed compacts of the samples were sintered under vacuum with the sintering temperature controlled within a range of 1020-1100° C. and the sintering time controlled within 2-10 h, and the sintered magnets were cooled to give sintered body samples D11, D12, D13, D14, D15, and D16.

### Example 3: Preparation of Nd—Fe—B Based Permanent Magnet Material

The processed sintered R-T-B based rare earth type magnet could be further subjected to a grain boundary diffusion process, wherein the diffusion source and the specific process method of the grain boundary diffusion are not particularly limited. For example, a compound comprising a heavy rare earth element could be adhered to the surface of the sintered R-T-B based rare earth type magnet by a coating method, a vapor deposition method, a magnetron sputtering method, and the like, followed by a heat treatment.

The sintered body samples D11, D12, D13, D14, D15, and D16 prepared in Example 2 were subjected to diffusion treatment to give the diffused Nd—Fe—B based permanent magnet material samples E11, E12, E13, E14, E15, and E16.

(1) Coating with Heavy Rare Earth Components

The heavy rare earth terbium (Tb) was placed on the surfaces of the magnets D11, D12, D13, D14, D15, and D16 by adopting a magnetron sputtering method, and the magnets were dried to give uniform and flat heavy rare earth alloy powder coating layers, wherein an average thickness of the diffusion coating layer was 50 μm.

### (2) Thermal Diffusion Treatment

The Nd—Fe—B sintered body samples with the surfaces adhered with the heavy rare earth alloy were placed into a vacuum sintering furnace for thermal diffusion treatment, wherein the diffusion temperature was 900° C., and the diffusion time was 30 h.

### (3) Tempering Treatment

The tempering treatment was carried out at a tempering temperature of 500° C. for 10 h to give the Nd—Fe—B based permanent magnet material samples E11, E12, E13, E14, E15, and E16.

### Comparative Example 1

A11 of the preparation example was adopted to perform hydrogenation pulverization on the alloy, followed by jet milling to give a magnetic powder with particle size SMD of 2.6 μm.

The jet-milled powder described above was mixed with 0.2 wt % (by weight of the starting materials) of lubricant zinc stearate, and the mixture was molded in an oriented magnetic field with a magnetic field intensity of 2 T.

The blank bodies were placed into a vacuum sintering furnace, subjected to heat preservation treatment at 1070° C. for 4 h, cooled to room temperature at the rate of 10° C./min, heated to 850° C., subjected to heat preservation treatment for 3 h, cooled to room temperature at the rate of 6° C./min, heated to 540° C., subjected to heat preservation treatment for 4 h, cooled to room temperature at the rate of 8° C./min, and then cooled to give an NdFeB blank, and sample D10 was prepared.

Sample D10 was diffused in the same manner as in Example 3 to give sample E10.

### Comparative Example 2

(1) Starting materials: various starting materials required for this example were prepared, and the mass percentage formula of the starting materials is shown in the following table.

TABLE
NdFeB powder formula (unit: wt %)

| | PrNd | Dy | Ho | Co | Cu | Ga | Al | Ti | B | Fe |
|---|---|---|---|---|---|---|---|---|---|---|
| A21 | 28.6 | 1.2 | 0 | 1.0 | 0.15 | 0.25 | 0.1 | 0.12 | 1.00 | Balance |
| A22 | 28.6 | 1.2 | 0 | 1.0 | 0.10 | 0.25 | 0.3 | 0.12 | 1.00 | Balance |

(2) The starting materials were high-frequency melted under an Ar atmosphere and casted on a quenching roller to give rapidly-solidified alloy scales A21 and A22 with a thickness of 0.15-0.40 mm.

(3) The alloy was subjected to hydrogenation pulverization and then to jet milling to give a magnetic powder with particle size SMD of 2.6 μm.

(4) The jet-milled powder described above was mixed with 0.2 wt % (by weight of the starting materials) of lubricant zinc stearate, and the mixture was molded in an oriented magnetic field with a magnetic field intensity of 2 T.

(5) The blank bodies were placed into a vacuum sintering furnace, subjected to heat preservation treatment at 1075° C. for 4 h, cooled to room temperature at the rate of 10° C./min, heated to 850° C., subjected to heat preservation treatment for 3 h, cooled to room temperature at the rate of 6° C./min, heated to 540° C., subjected to heat preservation treatment for 4 h, cooled to room temperature at the rate of 8° C./min, and then cooled to give NdFeB blanks, and samples D21 and D22 were prepared. Samples D21 and D22 were diffused in the same manner as in Example 3 to give samples E21 and E22.

### Comparative Example 3

The sintered body sample D10 prepared in Comparative Example 1 was subjected to diffusion treatment to give a diffused Nd—Fe—B based permanent magnet material sample E23.

(1) Coating with Heavy Rare Earth Components

A composite heavy rare earth diffusion source was prepared by mixing the heavy rare earth terbium (Tb) with an average particle size of 2.3 μm with B1 powder in Preparation Example 2, according to a ratio of 9:1 to give the composite heavy rare earth diffusion source.

The composite heavy rare earth diffusion source was placed on the surface of sample D10 by adopting a magnetron sputtering method, and the sample was dried to give a uniform and flat heavy rare earth alloy powder coating layer, wherein an average thickness of the diffusion coating layer was 50 μm.

### (2) Thermal Diffusion Treatment

The Nd—Fe—B sintered body samples with the surfaces adhered with the heavy rare earth alloy were placed into a vacuum sintering furnace for thermal diffusion treatment, wherein the diffusion temperature was 900° C., and the diffusion time was 30 h.

### (3) Tempering Treatment

The tempering treatment was carried out at a tempering temperature of 500° C. for 10 h to give the Nd—Fe—B based permanent magnet material sample E23.

### Comparative Example 4

A11 of the preparation example was adopted to perform hydrogenation pulverization on the alloy, followed by jet milling to give a magnetic powder with particle size SMD of 2.6 μm.

Sample A1 obtained in Preparation Example 1 and sample B1 obtained in Preparation Example 2 were mixed uniformly at different stages of powder preparation according to a ratio of 94:6, and after 0.2 wt % (by weight of the uniformly mixed powder) of lubricant zinc stearate was added, the materials were mixed such that the surfaces of the NdFEB powders were completely coated with M compounds to form a mixed powder C24 having coating layers of the M compounds.

Sample C24 was compression-molded in an oriented magnetic field to form a pressed compact with a density of 3.6-4.2 g/cm³, wherein the field intensity of the oriented magnetic field was 2-8 T, then the pressed compact was subjected to isostatic pressing to obtain a further increased density, and then a pressed compact without fine cracks inside was formed.

The pressed compact of the sample was sintered under vacuum with the sintering temperature controlled within a range of 1020-1100° C. and the sintering time controlled within 2-10 h, and the sintered magnet was cooled to give a sintered body sample D24.

Sample D24 was diffused in the same manner as in Example 3 to give sample E24.

### Test Example 1

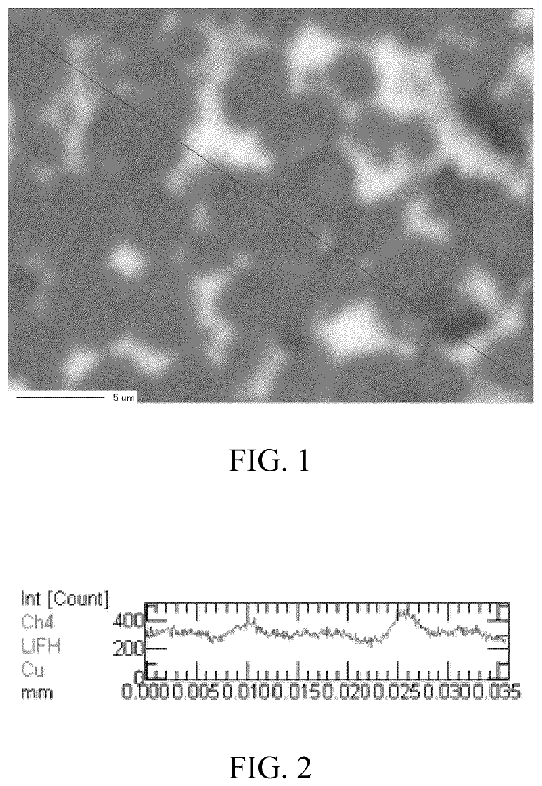

The vertically oriented surface of sample E11 described above was polished and detected by using a field-emission electron probe microanalyzer (FE-EPMA, commercially available from JEOL, model 8530F), and the detection on sample E11 is shown in FIG. 1.

EPMA line scanning was performed on a random region of FIG. 1, and the region in which the concentration of the compound M-R and/or M-T-R is not less than 115% of an average concentration of an entire scanning region is defined as an enrichment region of M-R and/or M-T-R in the grain boundary phases. The detection image is shown in FIG. 2. As can be seen from FIG. 2, the enrichment region of M-R and/or M-T-R (compounds) in the grain boundary phases had a peak region as seen in line scanning.

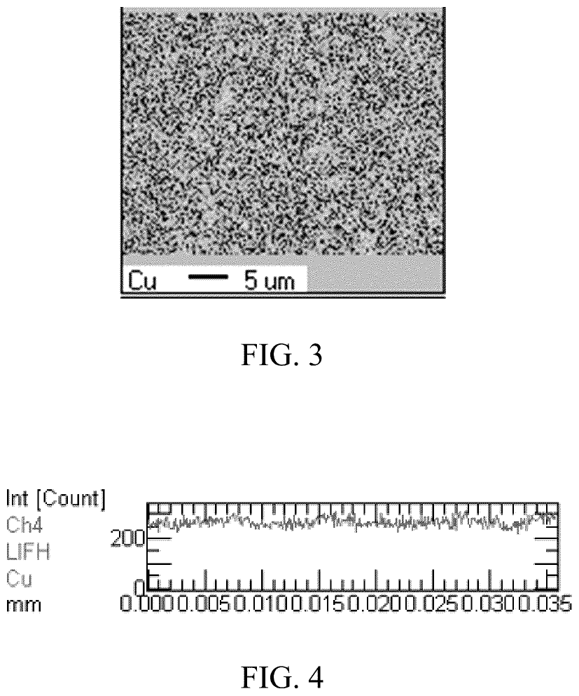

The detection image of E10 without M compound powder added in the comparative example is shown in FIG. 3, where the distribution of M (e.g., Al and/or Cu) between the grains and the grain boundaries inside the magnet was substantially uniform, and M was not enriched in the grain boundary phases.

EPMA line scanning was performed on a random region of FIG. 3, and the region in which the concentration of the compound M-R and/or M-T-R is not less than 115% of an average concentration of an entire scanning region is defined as an enrichment region of M-R and/or M-T-R in the grain boundary phases. The detection image is shown in FIG. 4. As can be seen from FIG. 4, the enrichment region of M-R and/or M-T-R (compounds) in the grain boundary phases had a flat and stable curve in line scanning, without a peak-enriched region.

### Test Example 2

The blanks of substrate samples D11, D12, D13, D14, D15, D16, D10, D21, D22, and D24 before diffusion and diffused samples E11, E12, E13, E14, E15, E16, E10, E21, E22, and E24 were respectively sampled, and the magnetic properties, the weight loss (experimental conditions: 121° C., 100% RH, 2.0 Bar) performance, and the mechanical properties thereof were tested.

All of the blanks were sampled for EPMA detection to analyze the characteristics of main phases and grain boundary phases, and quantitative analysis was carried out on the enrichment region percentage or the area of region A by using image analysis software Image-Pro Plus.

The results of the tests described above are shown in the following table:

| | | | Weight | Enrichment |
|---|---|---|---|---|
| | Br | Hcj | loss | region |
| Sample | (T) | (kA/m) | (mg/cm²) | percentage (%) |
| D11 | 1.438 | 1379 | 0.29 | 10.43 |
| D12 | 1.440 | 1378 | 0.29 | 11.32 |
| D13 | 1.441 | 1378 | 0.26 | 12.45 |
| D14 | 1.437 | 1380 | 0.27 | 12.65 |
| D15 | 1.438 | 1378 | 0.28 | 13.06 |
| D16 | 1.436 | 1382 | 0.27 | 13.67 |
| D10 | 1.440 | 1360 | 0.39 | 1.96 |
| E11 | 1.413 | 2178 | 0.30 | 10.06 |
| E12 | 1.417 | 2175 | 0.28 | — |
| E13 | 1.415 | 2177 | 0.25 | 12.24 |
| E14 | 1.414 | 2185 | 0.26 | — |
| E15 | 1.417 | 2174 | 0.27 | — |
| E16 | 1.416 | 2188 | 0.28 | — |
| E10 | 1.412 | 2144 | 0.38 | 1.67 |
| E21 | 1.409 | 2148 | 0.36 | 0.98 |
| E22 | 1.400 | 2155 | 0.39 | 1.86 |
| E23 | 1.415 | 2120 | 0.35 | 2.46 |
| E24 | 1.405 | 2080 | 0.33 | 18.65 |
| D24 | 1.421 | 1341 | 0.36 | 19.31 |
| D21 | 1.418 | 1346 | 0.35 | — |

“—” indicates “not detected”.

The percentages of the grain boundary phase of the M-R or M-Fe—R detected in samples D11, E11, D13, and E13 were found to be 10.43%, 10.06%, 12.45%, and 12.24% of the entire visual field area, and the ratios of the area of region A having an M element concentration of not less than 0.15 at % in the R-rich phase to the area of the R-rich phase, in the cross sections of samples D11, E11, D13, and E13, were found to be 82%, 85%, 87%, and 94%.

In Comparative Example 1, the percentages of the grain boundary phase of the M-R or M-Fe—R detected in samples D10 and E10 were 1.96% and 1.67% of the entire visual field area. In comparison with sample D11 added with the M compound, the coercivity of sample D10 without the M compound added was raised from 1360 kA/m to 1379 kA/m, where the remanence was comparable. Similarly, in comparison with sample E11 obtained after diffusion of sample D11 added with the M compound, the coercivity of sample E10 obtained after diffusion of sample D10 without the M compound added was raised from 2144 kA/m to 2178 kA/m, where the remanence was comparable.

In Comparative Example 2, in comparison with samples in Example 3, the coercivity and the remanence of samples D21, D22, E21, and E22 prepared by directly increasing the content of the M metal in the formula were both reduced, and the percentages of the grain boundary phase of the M-R or M-Fe—R detected in samples E21 and E22 were 0.98% and 1.86% of the entire visual field area; in the cross sections of samples E21 and E22, the ratios of the area of region A having an M element concentration of not less than 0.15 at % in the R-rich phase to the area of the R-rich phase were 67% and 76%.

In Comparative Example 3, the M compound and the heavy rare earth were diffused to the interior of the magnet, such that the coercivity and the remanence were synchronously improved, but the improved coercivity was slightly lower than that of Example 1. The percentage of the grain boundary phase of the M-R or M-Fe—R detected in sample E23 was 2.46% of the entire visual field area; in the cross section of sample E23, the ratio of the area of region A having an M element concentration of not less than 0.15 at % in the R-rich phase to the area of the R-rich phase was 72%; the weight loss effect thereof was also reduced compared to samples E11-E16 in this example.

In Comparative Example 4, in comparison of samples D11 and E11 in this example, the coercivity, remanence, weight loss, and other properties of the prepared samples D24 and E24 were significantly reduced by adding 6 wt % of the M compound; the percentages of the grain boundary phase of the M-R or M-Fe—R detected in samples D24 and E24 were 19.31% and 18.65% of the entire visual field area; in the cross section of sample E24, the ratio of the area of region A having an M element concentration of not less than 0.15 at % in the R-rich phase to the area of the R-rich phase was 95%; as the excessive M compounds were added, the excessive phases of the M-R or M-Fe—R were enriched in the grain boundaries, the requirements for the sintering process were high, the uniform sintering was difficult, and also, large particles were easily formed, and the defects of the grain boundaries were caused, thereby affecting the product performance.

In the cross sections of samples D13 and E13, the ratios of the area of region A having an M element concentration of not less than 0.15 at % in the R-rich phase to the area of the R-rich phase were 89% and 92%; in the cross sections of samples D21 and E21, the ratios of the area of region A having an M element concentration of not less than 0.15 at % in the R-rich phase to the area of the R-rich phase were 67% and 74%.

The test results described above show that the wettability of the NdFeB powders could be significantly improved by forming the uniform coating layers having the M compound on the surfaces of the NdFeB powders. The M compound reacted with the R-rich phase to form a new grain boundary phase or was dissolved in the R-rich phase to form a grain boundary phase of M-R or M-Fe—R, and when the percentage of the grain boundary phase of the M-R or M-Fe—R was 2%-18% of the entire visual field area, the physicochemical property of the grain boundary phase was easier to improve, the grain boundary was strengthened, the microstructure was improved, and the coercivity was improved. However, the samples without the M compound added in the comparative example were prone to have a reverse core-shell structure during diffusion, thereby affecting the diffusion effect. Moreover, the magnet had the problems of insufficient grain shape and a lot of defects on the grain surface layers and the grain boundaries, so Dy/Tb suffered from relatively large resistance when diffusing to the interior of the magnet along the grain boundaries, defects were easily repaired on the grain surface layers, or the Dy/Tb permeated into main phase grains, and the Dy or Tb cannot continuously diffuse to the interior of the magnet along the grain boundaries, and thus the phenomenon of insufficient Hcj amplification occurred.

The above examples illustrate the embodiments of the present disclosure. However, the protection scope of the present disclosure is not limited to the embodiments described above. Any modification, equivalent replacement, improvement, and the like made by those skilled in the art without departing from the spirit and principle of the present disclosure shall fall within the protection scope of the present disclosure.

1. An R-T-B based permanent magnet material, wherein the R is selected from one or two of neodymium (Nd) and praseodymium (Pr); the T comprises at least iron (Fe); the B is boron;
the permanent magnet material further comprises M, wherein the M is selected from one or more of transition metal elements, non-metal elements, and light rare earth elements;
a grain boundary of the permanent magnet material comprises an M compound selected from one, two, or more of compounds M-R and M-T-R;
preferably, the M is preferably selected from one or more of Cu, Ga, Al, Zr, Ti, Sn, Ta, and Mn, such as one or more of Cu, Ga, and Al;
the R is selected from Nd and NdPr;
the T is selected from iron and a mixture of iron and another metal element, wherein the another metal element can be selected from one or more of transition metal elements other than iron;
for example, the another metal element can be selected from one or more of copper (Cu), gallium (Ga), aluminum (Al), zirconium (Zr), titanium (Ti), tin (Sn), tantalum (Ta), and manganese (Mn).

2. The R-T-B based permanent magnet material according to claim 1, wherein the grain boundary of the permanent magnet material comprises a grain boundary phase selected from one or two of grain boundary phases of compounds M-R and M-T-R, for example, selected from one or two of grain boundary phases of M-Nd and M-Fe—Nd;
preferably, the grain boundary of the permanent magnet material comprises an enrichment region selected from grain boundary phases of M-R and/or M-T-R, wherein the enrichment region of M-R and/or M-T-R in the grain boundary phases refers to a region in which the concentration of the compound M-R and/or M-T-R is not less than 115% of an average concentration of an entire scanning region;
more preferably, the enrichment region of M-R and/or M-T-R in the grain boundary phases accounts for 2% to 18%, preferably 5% to 15%, even more preferably 8% to 12%, of an entire visual field area.

3. The R-T-B based permanent magnet material according to claim 1, wherein the mass percentage of the R is not less than 28.5% and not more than 32.5%, based on the mass of the permanent magnet material;
the mass percentage of the B is not less than 0.88% and not more than 1.05%, based on the mass of the permanent magnet material;
the total mass percentage of the M is not less than 0.1% and not more than 4.0%, preferably not less than 0.3% and not more than 3.5%, based on the mass of the permanent magnet material;
for example, the permanent magnet material comprises Ga; preferably, the mass percentage of the Ga is not less than 0.1% and not more than 0.6%, based on the mass of the permanent magnet material;
for example, the permanent magnet material comprises Co; preferably, the mass percentage of the Co is not less than 0% and not more than 3.0%, preferably not less than 0% and not more than 3.0%, based on the mass of the permanent magnet material;
for example, the permanent magnet material comprises Cu; preferably, the mass percentage of the Cu is not less than 0% and not more than 0.4%, preferably not less than 0% and not more than 0.4%, based on the mass of the permanent magnet material;
preferably, the balance of the permanent magnet material is Fe and an inevitable impurity.

4. The R-T-B based permanent magnet material according to claim 1, comprising a heavy rare earth element; wherein
the heavy rare earth element can be selected from one or more of gadolinium, terbium, dysprosium, holmium, erbium, thulium, ytterbium, lutetium, and yttrium;
preferably, a region A with an element concentration of the M being not less than 0.15 at % is present in a cross section of the permanent magnet material and in an R-rich phase, and the ratio of the area of the region A to the area of the R-rich phase is preferably not less than 80%, more preferably not less than 90%.

5. A mixture of R-T-B based alloy powders, comprising the R-T-B based alloy powders and an M compound selected from one or more of M compounds, wherein the R, T, B, and M independently have the definitions as defined in claim 1;
preferably, the M compound is adhered to the surface of the R-T-B based alloy powders; for example, at least a part of the surface of the alloy powders is covered with the M compound; more preferably, the surface of the alloy powders is preferably completely coated with the M compound to form a coating layer;
more preferably, the mass percentage of the M compound in the mixture is 0.01% to 5.0%, preferably 0.05% to 3.0%, more preferably 0.1% to 2.0%, based on the mass of the R-T-B based alloy powders in the mixture;
more preferably, the mixture of the R-T-B based alloy powders does not comprise a heavy rare earth element;
for example, the M compound is selected from one or more of hydrides, carbides, oxides, nitrides, fluorides, and oxyfluorides of the M.

6. An R-T-B based magnet substrate, comprising a sintered substrate comprising the mixture of the R-T-B based alloy powders, and a heavy rare earth element; wherein
for example, the heavy rare earth element is adhered to the surface of the substrate.

7. A method for preparing the R-T-B based permanent magnet material according to claim 1, comprising: performing a heat treatment on an R-T-B based magnet substrate,
wherein the R-T-B based magnet substrate, comprising a sintered substrate comprising the mixture of the R-T-B based alloy powders, and a heavy rare earth element,
the heavy rare earth element is adhered to the surface of the substrate,
preferably, the heat treatment includes a thermal diffusion treatment and a tempering treatment.

8. A method for preparing the mixture of the R-T-B based alloy powders according to claim 5, comprising: enabling the R-T-B based alloy powders to be in contact with the M compound selected from one or more of M compounds.

9. A method for preparing the R-T-B based magnet substrate according to claim 6, comprising:
molding the R-T-B based alloy powders into a molded body of the R-T-B based alloy powders;
sintering the molded body to obtain a sintered substrate comprising the R-T-B based alloy powders; and
enabling the heavy rare earth element to be in contact with the sintered substrate comprising the R-T-B based alloy powders; wherein
preferably, the heavy rare earth element is in contact with the sintered substrate comprising the R-T-B based alloy powders to form a coating layer of the heavy rare earth element on the surface of the substrate.

10. Use of the R-T-B based permanent magnet material according to claim 1 in the fields of motors, loudspeakers, magnetic separators, computer disk drives, magnetic resonance imaging devices, and the like, preferably use thereof as a motor rotor steel magnet in motors.
